(19) United States
(12) Patent Application Publication
(10) Pub. No.: US 2013/0164436 A1
(43) Pub. Date: Jun. 27, 2013

(54) THIN FILM MANUFACTURING APPARATUS, THIN FILM MANUFACTURING METHOD, LIQUID DROPLET EJECTING HEAD, AND INKJET RECORDING APPARATUS

(71) Applicants: Masahiro Yagi, Kanagawa (JP); Osamu Machida, Kanagawa (JP); Ryo Tashiro, Kanagawa (JP); Jochen Stollenwerk, Aachen (DE); Melanie Meixner, Aachen (DE); Norbert Pirch, Aachen (DE); Peter Abels, Aachen (DE); Stefan Mann, Aachen (DE)

(72) Inventors: Masahiro Yagi, Kanagawa (JP); Osamu Machida, Kanagawa (JP); Ryo Tashiro, Kanagawa (JP); Jochen Stollenwerk, Aachen (DE); Melanie Meixner, Aachen (DE); Norbert Pirch, Aachen (DE); Peter Abels, Aachen (DE); Stefan Mann, Aachen (DE)

(73) Assignee: RICOH COMPANY, Tokyo (JP)

(21) Appl. No.: 13/721,454

(22) Filed: Dec. 20, 2012

(30) Foreign Application Priority Data
Dec. 27, 2011 (JP) 2011-286156
Dec. 27, 2011 (JP) 2011-286157
Dec. 27, 2011 (JP) 2011-286158

(51) Int. Cl. B05D 3/02; B05C 9/14

(52) U.S. Cl. CPC B05D 3/0254; B05C 9/14
USPC 427/8; 118/642; 427/541; 118/713

(57) ABSTRACT

A thin film manufacturing apparatus is disclosed, including a liquid ejecting unit which ejects a liquid onto an object on which a film is to be formed and which forms a coating film; a first laser irradiating unit which continuously irradiates a laser light onto the coating film and which evaporates a solvent of the coating film; and a second laser irradiating unit which irradiates a laser light pulse onto the coating film of which the solvent is evaporated and which crystallizes the coating film of which the solvent is evaporated.

### TECHNICAL FIELD

The present invention relates to thin film manufacturing apparatuses and thin film manufacturing methods, liquid droplet ejecting heads, and inkjet recording apparatus having the liquid droplet ejecting heads.

### BACKGROUND ART

A liquid ejecting head and inkjet recording apparatus for use as an image recording apparatus or an image forming apparatus such as a printer, a facsimile machine, a copying machine, etc., are known that include a nozzle which ejects ink droplets; a pressure chamber with which the nozzle is communicatively connected; and an electro-mechanical transducer element such as a piezoelectric element which pressurizes ink within the pressure chamber.

The electro-mechanical transducer element includes a structure in which an electro-mechanical transducer film and an upper electrode are laminated on a lower electrode, for example. The electro-mechanical transducer film, which is a thin film, may be manufactured by a sputtering method, an MOCVD method, a vacuum deposition method, an ion plating method, a sol-gel method, an aerosol deposition method, etc., for example.

Here, a manufacturing method of the electro-mechanical transducer film using the sol-gel method is described as an example. First, a hydrophobic film pattern is formed on the lower electrode (process 1). A portion on the lower electrode on which the hydrophobic film pattern is not formed is hydrophilic. Next, only on the hydrophilic portion (the portion on which the hydrophobic film pattern is not formed) on the lower electrode a precursor coating film of the electro-mechanical transducer film is formed and a thermal treatment is performed (process 2). With the thermal treatment, the hydrophobic film pattern disappears.

The precursor coating film of the electro-mechanical transducer film is thin, so that it is not possible to form it in a predetermined film thickness in a one time treatment. Thus, processes 1 and 2 are repeated a required number of times to laminate the precursor coating film of the electro-mechanical transducer film and manufacture the electro-mechanical transducer film of a predetermined film thickness.

However, with the method of manufacturing the electro-mechanical transducer film as described above, the processes 1 and 2 are repeated a required number of times, so that the film thickness of the precursor coating film on which the thermal treatment is to be performed becomes different every time (the larger the number of times of repetition, the larger the film thickness becomes). Therefore, there is a problem that, even when the thermal treatment is performed under the same conditions in the process 2, it is not possible to heat to the same temperature due to a difference in a light absorption rate caused by a difference in the film thickness of the precursor coating film.

Patent Document
Patent document 1: Japanese Translation No. 2002-543429 of PCT Application

### DISCLOSURE OF THE INVENTION

In light of the problem as described above, an object of embodiments of the present invention is to provide a thin film manufacturing apparatus and a thin film manufacturing method which make it possible to perform a preferable heating treatment in accordance with a film thickness of a thin film to be heated.

According to an embodiment of the present invention, thin film manufacturing apparatus is provided, including a liquid ejecting unit which ejects a liquid onto an object on which a film is to be formed and which forms a coating film; a first laser irradiating unit which continuously irradiates a laser light onto the coating film and which evaporates a solvent of the coating film; and a second laser irradiating unit which irradiates a laser light pulse onto the coating film of which the solvent is evaporated and which crystallizes the coating film of which the solvent is evaporated.

Embodiments of the present invention make it possible to provide a thin film manufacturing apparatus and a thin film manufacturing method that make it possible to perform a preferable heating treatment in accordance with a film thickness of a thin film to be heated.

### BRIEF DESCRIPTION OF THE DRAWINGS

Other objects, features, and advantages of the present invention will become more apparent from the following detailed descriptions when read in conjunction with the accompanying drawings, in which:

FIG. 1 is a first part of a sectional view exemplifying a liquid ejecting head which uses an electro-mechanical transducer element;

FIG. 2 is a second part of the sectional view exemplifying the liquid ejecting head which uses the electro-mechanical transducer element;

FIG. 3 is a perspective view exemplifying a thin film manufacturing apparatus according to a first embodiment;

FIGS. 4A to 4D are first parts of a diagram exemplifying a thin film manufacturing process according to the present embodiment;

FIGS. 5A to 5C are second parts of the diagram exemplifying the thin film manufacturing process according to the present embodiment;

FIGS. 6A and 6B are third parts of the diagram exemplifying the thin film manufacturing process according to the present embodiment;

FIGS. 7A to 7D are fourth parts of the diagram exemplifying the thin film manufacturing process according to the present embodiment;

FIG. 8 is a diagram illustrating a relationship between a color depth and a film thickness;

FIG. 9 is a diagram for explaining a light absorption rate and the film thickness;

FIG. 10A is a diagram illustrating an example of a flowchart for measuring a relationship between the light absorption rate and the film thickness of a functional ink and FIG. 10B is a diagram illustrating an example of information obtained in step S102 in FIG. 10A;

FIG. 11 is a diagram illustrating a functional ink pattern recognized by a camera;

FIG. 12A is a diagram illustrating an example of information obtained in step S103 in FIG. 10A, and FIG. 12B is a diagram in which film thickness information obtained in FIG. 10B is plotted in FIG. 12A;

FIG. 13 is a perspective view exemplifying an inkjet recording apparatus;

FIG. 14 is a side view exemplifying a machinery section of the inkjet recording apparatus;

FIG. 15 is a photograph in which a water contact angle is measured in an SAM film forming part;

FIG. 16 is a photograph in which the water contact angle is measured in an SAM film removing part; and

FIG. 17 is graph showing a P-E hysteresis curve of the electro-mechanical transducer element manufactured in examples of the present invention.

### BEST MODE FOR CARRYING OUT THE INVENTION

A description is given below with regard to embodiments of the present invention with reference to the drawings. In the respective drawings, the same letters are applied to the same elements, so that duplicate explanations may be omitted.

### First Embodiment

### Thin Film

First, an electro-mechanical transducer film which makes up an electro-mechanical transducer element is described as an example of a thin film which is manufactured by a thin film manufacturing method and a thin film manufacturing apparatus according to a first embodiment. It is a matter of course that the thin film which can be manufactured by the thin film manufacturing method and the thin film manufacturing apparatus according to the first embodiment is not limited to the electro-mechanical transducer film.

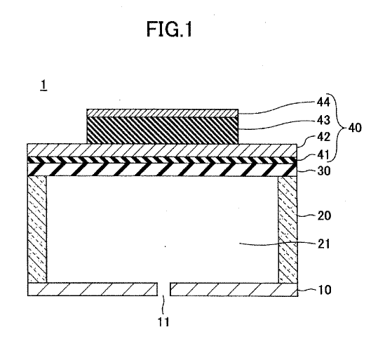

The electro-mechanical transducer element is used as a component of a liquid ejecting head used in an inkjet recording apparatus, for example. FIG. 1 is a sectional view exemplifying the liquid ejecting head which uses the electro-mechanical transducer element.

With reference to FIG. 1, a liquid droplet ejecting head 1 includes a nozzle plate 10; a pressure chamber substrate 20; a vibrating plate 30; and an electro-mechanical transducer element 40. A nozzle 11 which ejects ink droplets is formed in the nozzle plate 10. The nozzle plate 10, the pressure chamber substrate 20, and the vibrating plate 30 form a pressure chamber 21 (may also be called an ink flow path, a pressurizing liquid chamber, a pressurizing chamber, an ejecting chamber, a liquid chamber, etc.), which is communicatively connected to the nozzle 11. The vibrating plate 30 forms a part of a wall face of the ink flow path.

The electro-mechanical transducer element 40, which is configured to include a contact layer 41, a lower electrode 42, an electro-mechanical transducer film 43, and an upper electrode 44, includes a function of pressurizing ink within the pressurizing chamber 21. The contact layer 41, which is a layer including Ti, TiO₂, TiN, Ta, Ta₂O₅, Ta₃N₅, etc., for example, includes a function of improving adhesion between the lower electrode 42 and the vibrating plate 30. However, the contact layer 41 is not a mandatory element of the electro-mechanical transducer element 40.

When a voltage is applied between the lower electrode 42 and the upper electrode 44 in the electro-mechanical transducer element 40, the electro-mechanical transducer film 43 is mechanically displaced. With the mechanical displacement of the electro-mechanical transducer film 43, the vibrating plate 30 is deformed and displaced in a lateral direction (a d31 direction), for example, pressurizing the ink within the pressure chamber 21. This makes it possible to cause ink droplets to be ejected from the nozzle 11.

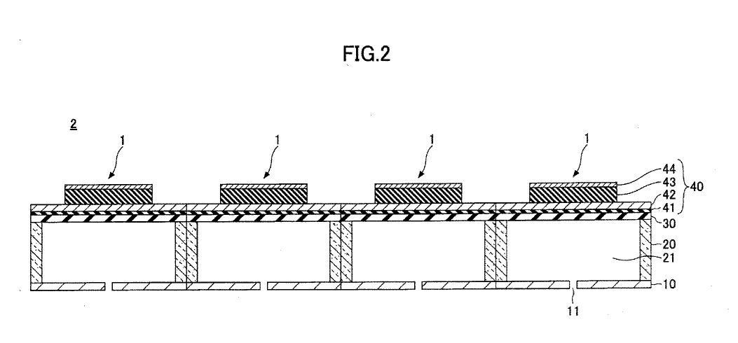

As shown in FIG. 2, multiple of the liquid droplet ejecting heads 1 may also be installed together to configure a liquid droplet ejecting head 2.

As a material for the electro-mechanical transducer film 43, PZT may be used, for example. PZT is a solid solution of lead zirconate (PbZrO₃) and lead titanate (PbTiO₃). For example, a PZT, etc., may be used at a ratio between PbZrO₃ and PbTiO₃ of 53:47, which is expressed in a chemical formula as Pb(Zr_{0.53}, Ti_{0.47})O₃ and generally denoted as PZT (53/47). The properties of PZT vary depending on the ratio between PbZrO₃ and PbTiO₃.

When using PZT for the electro-mechanical transducer film 43, a lead acetate, a zirconium alkoxide compound, and a titanium alkoxide compound, which are used as starting materials, are dissolved in methoxyethanol as a common solvent to produce a PZT precursor solution. A skilled person may appropriately select an amount of mixture of the lead acetate, the zirconium alkoxide compound, and the titanium alkoxide compound in accordance with a desired PZT composition the ratio between PbZrO₃ and PbTiO₃).

A metal alkoxide compound is easily hydrolyzed by moisture in the atmosphere. Therefore, a stabilizer, such as acetylacetone, acetic acid, diethanolamine, etc., may be added to the PZT precursor solution.

As the material for the electro-mechanical transducer film 43, barium titanate, etc., may also be used, for example. In this case, a barium alkoxide and a titanium alkoxide compound, which are used as starting materials, can be dissolved in a common solvent to produce a barium titanate precursor solution.

Complex oxides with A=Pb, Ba, Sr; B═Ti, Zr, Sn, Ni, Zn, Mg, Nb as main components apply to such materials described with a general formula ABO₃. A specific description thereof may be (Pb₁₋ₓ,Ba)(Zr,Ti)O₃, (Pb₁₋ₓ,Sr)(Zr,Ti)O₃, which is a case in which Pb in site A is partially replaced by Ba and Sr. Such replacement is possible for a bivalent element, the effect of which is that an action of reducing characteristic deterioration due to evaporation of lead during a thermal treatment is demonstrated.

As a material for the lower electrode 42, a metal, etc., which have a high heat resistance and which form an SAM film by a reaction with alkanethiols as shown below, may be used. More specifically, platinum group metals such as ruthenium (Ru), rhodium (Rh), palladium (Pd), osmium (Os), iridium (Ir), platinum (Pt), etc., or alloy materials, etc., including these platinum group metals may be used.

Moreover, after producing these metal layers, a conductive oxide layer may be laminated to use the laminated result. More specifically, as the conductive oxide, there is a complex oxide, which is described with a chemical formula ABO₃ and which has A=Sr, Ba, Ca, La, B═Ru, Co, Ni as main components, including SrRuO₃, CaRuO₃; (Sr₁₋ₓCaₓ)O₃, which is a solid solution thereof; as well as LaNiO₃, SrCoO₃, and (La,Sr)(Ni_{1-y}Co_{y})O₃ (may be y=1), which is a solid solution thereof. Other oxide materials also include IrO₂, RuO₂.

The lower electrode 42 may be produced by methods such as a vacuum film forming method, etc., including vapor deposition, sputtering, etc., for example. The lower electrode 42 is used for an electrical connection as a common electrode for inputting a signal into the electro-mechanical transducer element 40, so that, for a vibrating plate 30 thereunder, an insulator, or a conductor whose surface is insulated may be used.

As a specific material for the vibrating plate 30, silicon may be used, for example. Moreover, as a specific material for insulating the surface of the vibrating plate 30, a silicon oxide film, a silicon nitride film, or a silicon oxynitride film of a thickness of approximately a few hundred nm to a few μm, a film in which these films are laminated, etc., may be used. Moreover, taking into account a thermal expansion difference, a ceramic film such as an aluminum oxide film, a Zirconia film, etc., may be used. A silicon-based insulating film which insulates the surface of the vibrating plate 30 may be formed by a thermal oxidation treatment of silicon, a CVD method, etc. Moreover, a metal oxide film such as an aluminum oxide film, etc., which insulates the surface of the vibrating plate 30 may be formed by sputtering, etc.

Thin Film Manufacturing Apparatus

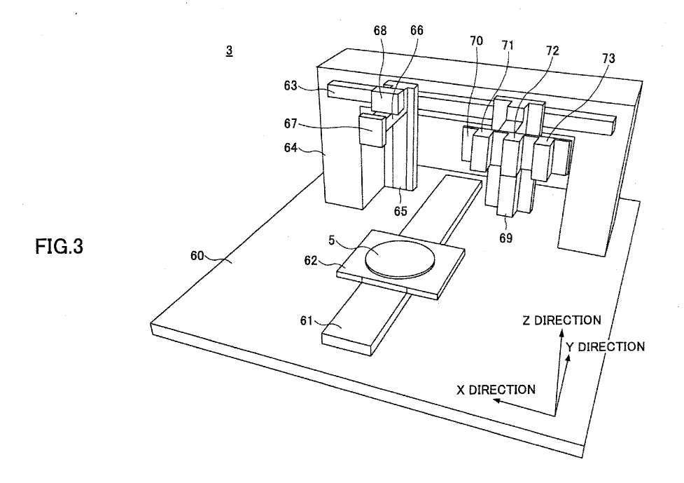

Next, a structure of a thin film manufacturing apparatus according to the first embodiment is described. FIG. 3 is a perspective view exemplifying a thin film manufacturing apparatus according to the first embodiment. With reference to FIG. 3, a Y-axis drive unit 61 is installed on a platform 60 in the thin film manufacturing apparatus 3. On the Y-axis drive unit 61 is installed a stage 62 which has installed thereon a substrate 5 such that the stage 62 can drive in a Y-axis direction.

The stage 62 normally accompanies an adsorbing unit (not shown) which uses a vacuum, static electricity, etc., by which adsorbing unit the substrate 53 may be fixed. Moreover, also have the stage 62 installed thereon a drive unit (not shown) which rotates around a Z axis to correct a tilt of an inkjet head 67, a continuous laser irradiating apparatus 71, and a pulse laser irradiating apparatus 72, and an gin unit 73 that are described below, relative to the substrate 5.

Moreover, an X-axis supporting member 64 for supporting an X-axis drive unit 63 is installed on the platform 60. On the X-axis drive unit 63 is installed a Z-axis drive unit 65, on which is mounted a head base 66, which is arranged to move in X-axis and Z-axis directions.

The Z-axis drive unit 65 may control a distance between the substrate 5 and the inkjet head 67 described below. On the head base 66 is installed the inkjet head 67 which ejects a functional ink (a PZT precursor solution, for example). To the inkjet head 67 is provided a functional ink via an ink-supplying pipe (not shown) from each ink tank 68.

On the X-axis drive unit 63 is mounted a different Z-axis drive unit 69, on which Z-axis drive unit 69 a laser support member 70 is mounted. On the laser support member 70 may be mounted the continuous laser irradiating apparatus 71 and the pulse laser irradiating apparatus 72 as well as the imaging apparatus 73. The z-axis drive unit 69 may drive a distance between the substrate 5, and the continuous laser irradiating apparatus 71, the pulse laser irradiating apparatus 72 and the imaging apparatus 73. As the imaging unit 73, a CCD camera, etc., may be used.

While FIG. 3 shows a configuration in which the stage 1 has a degree of freedom of one axis in a Y direction and the inkjet head 67, the continuous laser irradiating apparatus 71, the pulse laser irradiating apparatus 72, and the imaging unit 73 has a degree of freedom of one axis in an X direction, it is not limited thereto. For example, the stage 62 may be configured to have a degree of freedom of two axes in the X and Y directions and fix the inkjet head 67, the continuous laser irradiating apparatus 71, the pulse laser irradiating apparatus 72, and the imaging unit 73. Moreover, the stage 62 may be configured to have a degree of freedom of one axis in the Y direction and align the inkjet head 67, the continuous laser irradiating apparatus 71, the pulse laser irradiating apparatus 72, and the imaging unit 73 in the Y-axis direction.

Moreover, it may be configured to fix the substrate 5, and, for the inkjet head 67, the continuous laser irradiating apparatus 71, the pulse laser irradiating apparatus 72, and the imaging unit 73 to have a degree of freedom of two axes in the X and Y directions. Furthermore, it is not necessary for the X axis and the Y axis to be orthogonal as long as one plane may be expressed with X-axis and Y-axis vectors, so that the X-axis vector may have an angle of 30, 45, or 60 degrees formed with the Y-axis vector.

The thin film manufacturing apparatus 3, which has an apparatus control unit (not shown), may control ejection conditions of the functional ink of the inkjet head 67 and laser irradiating conditions of the continuous laser irradiating apparatus 71 and the pulse laser irradiating apparatus 72.

An apparatus control unit includes a CPU, a ROM, a RAM, a non-volatile memory, a main memory, etc., for example, various functions of which apparatus control unit are realized by a control program recorded in the ROM, etc., by a control program recorded in the ROM, etc., being read into the main memory to be executed by the CPU. A part or the whole of the apparatus control unit may be realized by hardware only.

Moreover, the apparatus control unit may physically be configured by multiple apparatuses. In a recording unit such as the RAM, the non-volatile memory, etc., may be recorded a crystalline state of the functional ink and optimal laser irradiating conditions, etc. For example, a laser power storage unit, a color depth converting unit, a film thickness calculating unit, an irradiating power calculating unit, a shape determining unit, etc., according to the present embodiment can be realized with an apparatus control unit.

Thin Film Manufacturing Method

Next, a thin film manufacturing method according to the first embodiment is described. Here, an example is shown of manufacturing the electro-mechanical transducer film 43 as the thin film, which is shown in FIG. 1.

Patterning of SAM Film

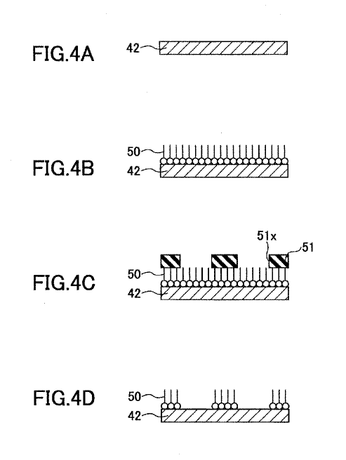

First, as shown in FIGS. 4A to 4D, a SAM (Self Assembled Monolayer) film 50 of a predetermined pattern is formed on a surface of the lower electrode 42. More specifically, in a process shown in FIG. 4A, a substrate to be the lower electrode 42 is prepared. As the lower substrate 42, platinum (Pt) may be used, for example.

Next, in a process shown in FIG. 4B, the lower electrode 42 is soaking treated with a SAM material including alkanethiols, etc. In this way, on a surface of the lower electrode 42 the SAM material reacts, so that the SAM film 50 is affixed thereto, making it possible to make the surface of the lower electrode 42 water repellent. Alkanethiols, which vary in reactability and hydrophobicity (water repellency) depending on a molecular chain length, are normally produced by dissolving a molecule with the number of carbon atoms between 6 and 18 in an organic solvent such as alcohol, acetone, toluene, etc. Normally, a concentration of alkanethiols is approximately a few mols/liter. After a predetermined time period, the lower electrode 42 is taken out, excessive molecules undergo replacement cleaning by the solvent and drying.

Next, in a process shown in FIG. 4C, using a known photolithographic method, a photoresist 51 having an opening 51x is formed on the SAM film 50 which is formed on the surface of the lower electrode 42. Then, in a process shown in FIG. 4D, using dry etching, etc., the SAM film 50 which is exposed within the opening 51x is removed, and furthermore the photoresist 51 is removed. In this way, the SAM film 50 of a predetermined pattern is formed on a surface of the lower electrode 42.

A region on which the SAM film 50 is formed on a surface of the lower electrode becomes hydrophobic. On the other hand, a region on which the SAM film 50 is removed so that the surface of the lower electrode 42 is exposed becomes hydrophilic. A contrast of the surface energy can be used to coat the PZT precursor solution differently as described in detail below.

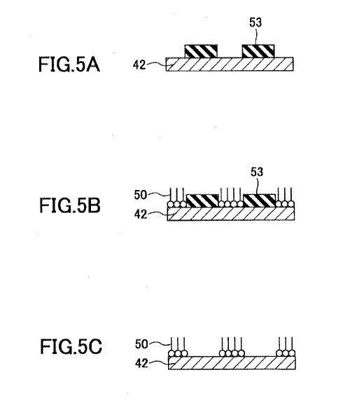

After the process shown in FIG. 4A, as in a process shown in FIG. 5A, a photoresist 53 may be formed on the surface of the lower electrode 42, an SAM treatment may be performed as in a process shown in FIG. 5B, and the photoresist 53 may be removed as in the process shown in FIG. 5C. In this way, in the same manner as the process shown in FIG. 4D, the SAM film 50 of a predetermined pattern is formed on the surface of the lower electrode 42.

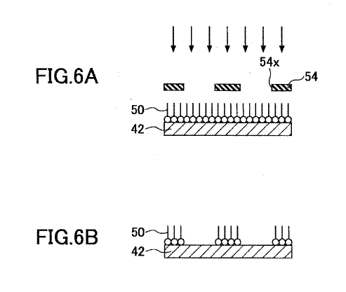

Moreover, after the process shown in FIG. 4B, as in a process shown in FIG. 6A, ultraviolet rays, oxygen plasma, etc., may be irradiated onto the surface of the lower electrode 42 via a photomask 54 having an opening 54x as in a process shown in FIG. 6A and the SAM film 50 of an exposing portion (within the opening 54x) may be removed as shown in a process shown in FIG. 6B. In this way, in the same manner as the process shown in FIG. 4D, an SAM film 50 of a predetermined pattern is formed on the surface of the lower electrode 42.

Forming Electro-Mechanical Transducer Film

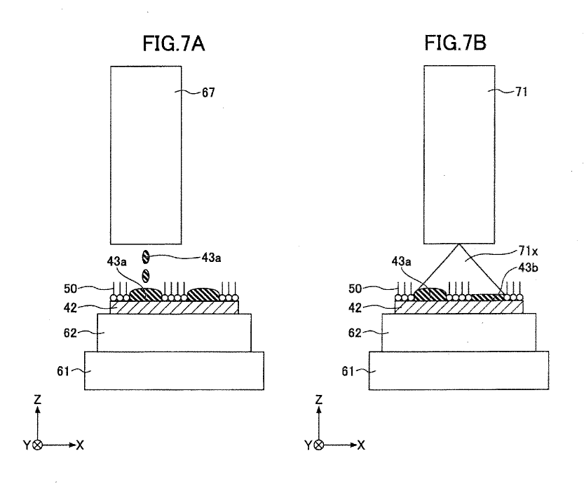

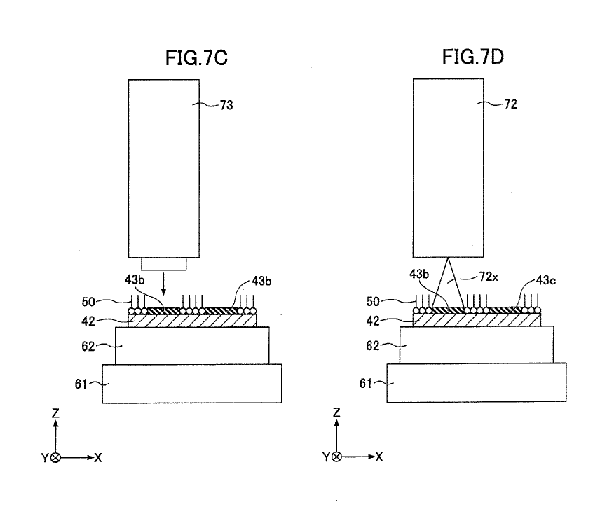

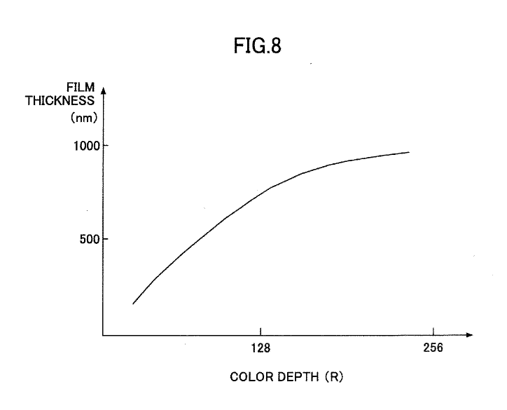

Next, as shown in FIGS. 7A to 7D, an electro-mechanical transducer film 43 is formed on the surface of the lower electrode 42. More specifically, in the process shown in FIG. 7A, the lower electrode 42 (corresponding to the substrate 5 in FIG. 3) on which surface the SAM film 50 of a predetermined pattern is formed is placed on the stage 62 of the thin film manufacturing apparatus 3. Then, using a well known alignment apparatus (a CCD camera, a CMOS camera, etc.), etc., a position, tilt, etc., of the lower electrode 42 is aligned.

Then, the inkjet head 67 is driven to the X axis and the stage 62 on which the lower electrode 42 is placed is driven to the Y axis, so that the inkjet head 67 is arranged on the stage 62. Then, a functional ink 43a is ejected from the inkjet head 67 onto a region (a hydrophilic region) on which there is no SAM film 50 on the surface of the lower electrode 42. Here, due to a contrast of the surface energy, the functional ink 43a undergoes wet spreading only onto a region on which there is no SAM film 50 (a hydrophilic region).

In this way, a contrast of the surface energy can be used to form a functional ink 43a only onto a region on which there is no SAM film 50 (a hydrophilic region) to decrease an amount of use of a solution for coating relative to a process such as spin coating, etc., and simplify the process. As the functional ink 43a, a PZT precursor solution may be used, for example.

Next, in the process shown in FIG. 7B, a continuous laser irradiating apparatus 71 is driven to the X axis and, as needed, a stage 62 on which the lower electrode 42 is placed is driven to the Y axis to arrange the continuous laser irradiating apparatus 71 on the stage 62. Then, in the continuous laser irradiating apparatus 71, the functional ink 43a which underwent wet spreading in the process shown in FIG. 7A undergoes irradiation of the laser light 71x and heating. The functional ink 43a on which the laser light 71x is irradiated, a solvent of which evaporates, is thermally decomposed, and becomes a functional ink 43b which is thermally decomposed. As the continuous laser irradiating apparatus 71, a semiconductor laser apparatus, a YAG laser apparatus, etc., may be used, for example.

A wavelength of the laser light 71x is preferably set to be greater than or equal to 400 nm (for example, in the order of between 400 nm to 10000 nm), which is a region in which a light absorption rate of the substrate including the lower electrode 42 is relatively high. Explaining in more detail, the functional ink 43a almost transmits and poorly absorbs the laser light 71x whose wavelength is greater than or equal to 400 nm. Therefore, the functional ink 43a is not directly heated, while a substrate which includes the lower electrode 42 (platinum, etc.) which has mounted thereon the functional ink 43a is heated, and in conjunction therewith the functional ink 43a is indirectly heated. Therefore, the wavelength of the laser light 71x is preferably set to be greater than or equal to 400 nm, in which a light absorption rate of the lower electrode 42 is relatively high.

While unevenness of a beam profile of the laser light could cause temperature unevenness in the irradiating portion to occur when a direct heating method is used, an indirect heating method can be adopted to heat the functional ink 43a uniformly within the irradiating face.

Moreover, while the functional ink 43a is formed on the lower electrode 42 in the above explanation, the lower electrode 42 which includes platinum, etc., and the contact layer 41 which includes titanium, etc., may be laminated on the vibrating plate 30 made of silicon, forming the functional ink 43a on the laminated lower electrode 42. Even in this case, the wavelength of the laser light 71x is preferably set to be greater than or equal to 400 nm, in which region a light absorption rate of silicon, titanium, and platinum is relatively high.

Silicon, which has low unevenness of thickness and crystallization and thermal properties within a face, has a high reliability, so that it is suitable for a substrate (the vibrating plate 30) which is used in the present embodiment.

A moving speed of the lower electrode 42 may be set to be approximately 10 mm/s to 1000 mm/s, while a power of the laser light 71x may be set to be approximately a few W to a few ten W. Moreover, a beam diameter of the laser light 71x may be set to be in the order of a few ten μm to a few hundred μm, while the beam profile may be set to be a general Gaussian profile.

The laser light 71x is also irradiated onto the SAM film 50, so that the SAM film 50 is also heated. While the SAM film 50 could disappear when it reaches a temperature of greater than or equal to 500° C., a temperature of the lower electrode 42 remains at less than or equal to 500° C., so that the SAM film 50 does not disappear.

Next, in the process shown in FIG. 7C, the imaging unit 73 is driven to the X axis and, as needed, the stage 62 on which the lower electrode 42 is placed is driven to the Y axis to arrange the imaging unit 73 on the stage 62. Then, in the imaging unit 73, a pattern of the functional ink 43 which was thermally decomposed in the process shown in FIG. 7B is imaged. The imaging unit 73 is preferably arranged such that the whole area of the functional ink 43b can be imaged at once.

A pattern image of the functional ink 43b that is imaged by the imaging unit 73 is taken into an apparatus control unit (not shown) of the thin film manufacturing apparatus, and colors of the pattern is converted into a color depth. The colors of the pattern may be converted into the color depth of 256 gradations for each of R, G, and B, for example.

While a relationship between the color depth and the film thickness changes in accordance with a range of the film thickness, as shown in FIG. 8, the relationship between the color depth and the film thickness for red (R) becomes almost linear for the film thickness of 2 μm as in the present embodiment. Therefore, using this relationship, a film thickness may be determined from the color depth. While the relationship between the color depth and the film thickness for red (R) is used in the present embodiment, the relationship between the color depth and the film thickness for green (G) or blue (B) may be used. It is preferable to determine the film thickness from the color depth for the color for which the relationship between the color depth and the film thickness is more linear.

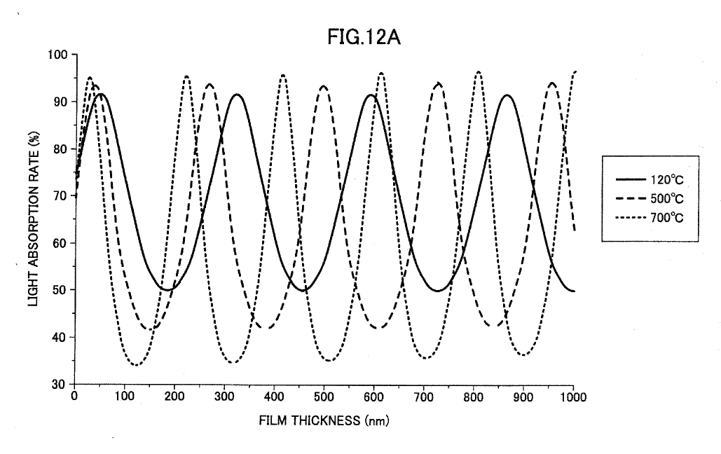

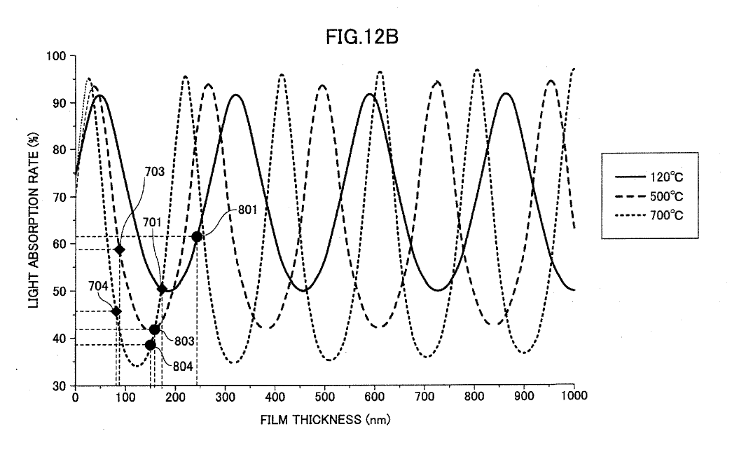

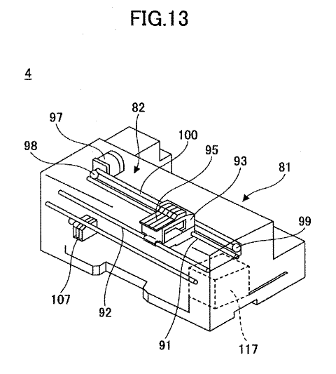

Moreover, as shown in FIG. 12A, the light absorption rate of a laser light changes in accordance with the film thickness. FIG. 12A plots the light absorption rate when a light with a wavelength of approximately 1000 nm is irradiated. In FIG. 12A, a solid line represents a light absorption rate for a film thickness of the functional ink film of between 0 and 1000 μm when burned at 120° C. for a few minutes with the hot plate; a rough dotted line represents a light absorption rate for a film thickness of the functional ink film of between 0 and 1000 μm when burned at 500° C. for a few minutes with the oven; and a fine dotted line represents a light absorption rate for a film thickness of the functional ink film of between 0 and 1000 μm when burned at 700° C. for a few minutes with the oven.

With actual data being measured in a few tens of micrometers, FIG. 12A shows curve-fitted results. Spin coat film forming conditions or inkjet ejecting conditions can be changed to change a film thickness in increments of a few ten μm. While temperatures for measurement in the present embodiment are 120° C., 500° C., and 700° C., it is a matter of course that more accurate information is obtained by obtaining data up to 25° C. or data in finer temperature increments.

A film thickness of a functional ink film may be measured using a non-contact shape measuring machine, etc., using a light, etc. for example. More specifically, an interferometer New View series by Zygo Corporation, a laser shape-measuring laser microscope VK series by Keyence Corporation, etc., may be used, for example. The light absorption rate may be measured using FTIR, UV-VIS-NIR Spectrometry, etc., for example. More specifically, IR series and UV series by Shimadzu Corporation, Lambda series by Perkin Elmer, Inc., etc., may be used, for example.

Based on the relationships in FIGS. 8 and 12A, a light absorption rate of the functional ink 43b may be determined from the color depth of the pattern image of the functional ink 43b. Moreover, when the light absorption rate is determined, an optimal laser power in accordance with the light absorption rate may be calculated, so that, after all, an optimal laser power to be irradiated onto the functional ink 43b of the film thickness may be determined from the color depth of the pattern image of the functional ink 43b.

In order to determine an optimal laser power, first, an optimal laser power to be used as a reference is determined by prior evaluation. For example, suppose an optimal laser power for heating the functional ink 43b of the film thickness 100 nm to 700° C. is 100 W. From FIG. 12A, the light absorption rate in this case is approximately 36%.

With this as a reference, an optimal laser power for different film thicknesses may be determined. For example, from FIG. 12A, the light absorption rate of the functional ink 43b of the film thickness 200 nm is approximately 82%. Therefore, 36%/82% of 100 W, or approximately 44 W is an optimal laser power for heating the functional ink 43b of the film thickness of 200 nm to 700° C.

Then, the relationship between the optimal laser power and the color depth of the pattern image of the functional ink 43b is stored in advance as data in a non-volatile memory, a RAM of the apparatus control unit (not shown). In this way, in the process shown in FIG. 7C, the apparatus control unit may determine an optimal laser power to be irradiated onto the functional ink 43b from a pattern image of the functional ink 43b that is imaged by the imaging unit 73.

Next, in the process shown in FIG. 7D, a pulse laser irradiating apparatus 72 is driven to the X axis and, as needed, the stage 62 on which the lower electrode 42 is placed is driven to the Y axis to arrange the pulse laser irradiating apparatus 72 on the stage 62. Then, in the pulse laser irradiating apparatus 72, the laser light 72x is irradiated onto and heats only the functional ink 43b which is decomposed in the process shown in FIG. 7B. In other words, when the laser light 72x is irradiated onto the SAM film 50, as the temperature of the lower electrode 42 reaches 500° C. or above, the SAM film 50 could disappear, so that the laser light 72x is not irradiated onto the SAM film 50.

The functional ink 43b, onto which the laser light 72x is irradiated, crystallizes to become a functional ink 43c (a PIT thin film, for example), so that the SAM film 50 remains, without disappearing. As the pulse irradiating laser apparatus 72, a semiconductor fiber coupling laser apparatus, a semiconductor laser stack apparatus may be used, for example.

A power of the laser light 72x to be irradiated in this process is an optimal power determined in the process shown in FIG. 7C. A temperature needed for crystallizing the functional ink 43b is approximately 700° C., so that an optimal power is irradiated which is determined using the data of 700° C. in FIG. 12A. Power of the laser light 72x may be set to approximately a few W to a few ten W.

An irradiating time of the laser light 72x may be set to approximately a few μm to a few hundred μm. A light emitting frequency of the laser light 72x is preferably adjusted in accordance with a pattern of the functional ink 43b and a moving speed of the stage 62. For example, when a pattern interval is 100 μm and a moving speed of the stage 62 is 100 mm/s, the light emitting frequency of the laser light 72x may be set to 1 kHz.

When the stage 62 moves while the laser light 72x is emitting light, a range of irradiating the laser light 72x becomes wider. For example, when the irradiating time is 100 μm and the moving speed of the stage 62 is 100 mm/s, the stage 62 moves when the laser light 72x emits light, so that a range of irradiating the laser light 72x becomes wider by approximately 10 μm.

Therefore, in order to irradiate the laser light 72x onto only the functional ink 43b and not onto the SAM film 50, it is necessary to emit the laser light 72x at an irradiation timing which matches a pattern shape of the functional ink 43b, taking into account an irradiating range of the laser light 72x.

While a multi-channel one or a one with a singular port may be used for the pulse laser irradiating apparatus 72, it is preferable to use the multi-channel one. This is because, as shown in a below-described example in FIG. 11, a laser light may be irradiated onto each pattern at a stretch when multiple patterns are installed together.

A film thickness of the functional ink 43c (for example, a PZT thin film) which is crystallized in the process shown in FIG. 7D is approximately a few tens of nanometers. The film thickness is inadequate, so that after the process shown in FIG. 7D, processes shown in FIGS. 7A to 7D may be repeated a required number of times. In this way, the functional ink 43c is laminated, and a crystallized functional ink film, or in other words the electro-mechanical transducer film 43 is produced on the lower electrode 42 with an arbitrary pattern and thickness (approximately a few μm, for example).

Here, while the film thickness of the functional ink 43c changes (increases) each time each process is repeated, an optimal laser power to be irradiated onto the functional ink 43b is determined each time from a pattern image of the functional ink 43b that is imaged by the imaging unit 73 in the process shown in FIG. 7C, an optimal laser power corresponding to the film thickness of the functional ink 43b may always be irradiated in the process shown in FIG. 7D.

In this way, in the first embodiment, at a temperature level such that the SAM film 50 does not disappear, the functional ink 43a undergoes irradiation of the laser light 71x and heating by the continuous laser irradiating apparatus 71, a solvent of the functional ink 43a is evaporated and thermally decomposed, and the functional ink 43b is produced. Then, the functional ink 43b undergoes irradiation of the laser light 72x (pulse) and heating, and is crystallized to produce the functional ink 43c. In this case, with the pulse laser irradiating apparatus 72, the laser light 72x is not irradiated onto the SAM film 50, which does not disappear and thus remains.

In this way, the functional ink 43c may be laminated by repeating a required number of times only the processes shown in FIGS. 7A to 7D, without having to repeat the processes in FIGS. 4A to 6B. In other words, a thin film such as an electro-mechanical transducer film can be manufactured by a simple process.

Now, when the functional ink 43c is laminated, a film thickness becomes thick, so that a light absorption rate of the functional ink 43c changes. When the light absorption rate changes, a temperature to heat to differs even when a laser light of the same power level is irradiated. Therefore, in the processes shown in FIGS. 7B and 7D, in order to heat the functional ink 43c to a certain temperature, it is preferable to set a power level of the laser light to irradiate onto the functional ink 43c in correspondence with the number of times the functional ink 43c is laminated. (In other words, it is preferable to set it in correspondence with the film thickness of the functional ink 43.) A method of setting a power level of the laser light in correspondence with a film thickness of the functional ink 43c is described below.

In the process shown in FIG. 7D, an optimal laser power corresponding to a film thickness of the functional film 43b may always be irradiated since an optimal laser power to be irradiated onto the functional ink 43b is determined each time from a pattern image of the functional ink 43b that is imaged by the imaging unit 73 in FIG. 7C.

In the above explanations, a laser light is irradiated with an optimal laser power only in the process shown in FIG. 70. This is because a power setting of continuously irradiating laser light may be relatively rough as the continuously irradiating laser light in the process shown in FIG. 7B has a large range of tolerance in unevenness relative to the pulse irradiating laser light in the process shown in FIG. 70.

However, also in the process shown in FIG. 7B, the laser power may be optimized by the same method as the process shown in FIG. 70. In this case, a temperature needed for evaporating a solvent of the functional ink 43a is approximately 120° C., so that first an optimal power is irradiated which is determined using data of 120° C. in FIG. 12A. Moreover, a temperature needed for thermally decomposing the functional ink 43a is approximately 500° C., so that after the evaporating of the solvent, an optimal power is irradiated which is determined using data of 500° C. in FIG. 12A.

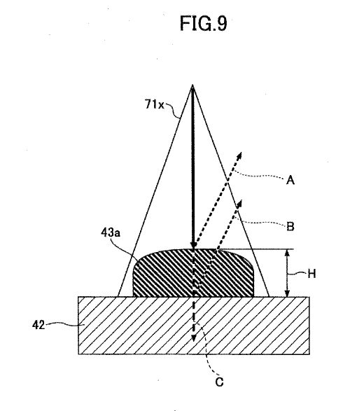

FIG. 9 is a diagram for explaining the light absorption rate and the film thickness. When the functional ink 43a is coated on the lower electrode 42 and the laser light 71x is irradiated thereonto, a part of the laser light 71x is reflected on a film surface of the functional ink 43a (A); a part thereof is transmitted through the functional ink 43a to be reflected on a surface of the lower electrode 42 (B), and a part is absorbed in the lower electrode 42 (C). A part may also be transmitted through the lower electrode 42. A light absorption rate of the functional ink 43a changes with a film thickness H of the functional ink 43a. The same applies to the functional ink 43b.

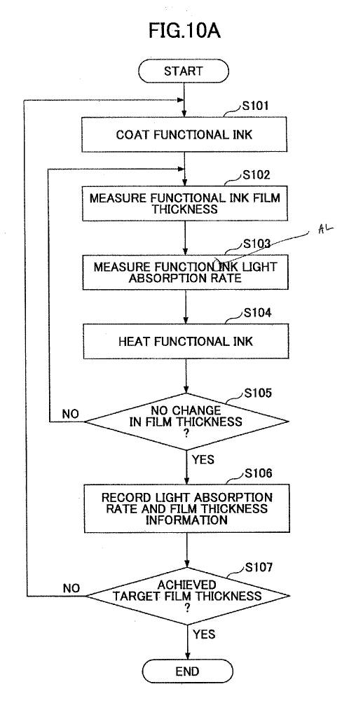

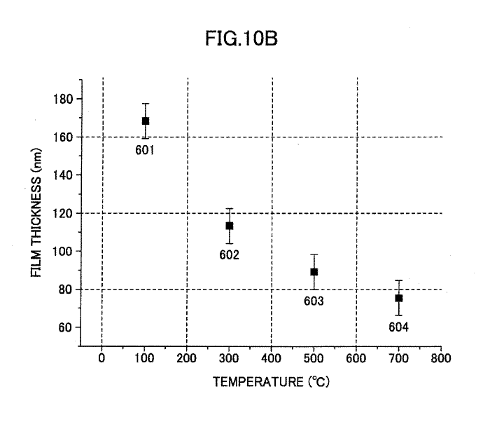

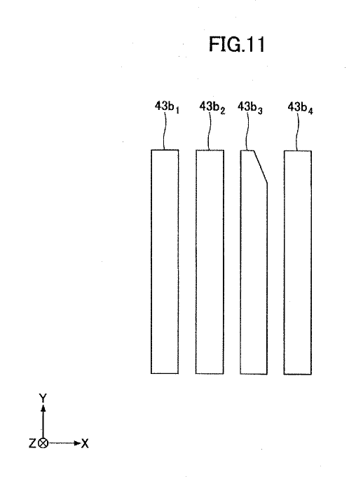

Thus, it is necessary to measure a relationship between the light absorption rate and the film thickness of the functional ink 43a. FIG. 10A is an example of a flowchart for measuring a relationship between the light absorption rate and the film thickness of a functional ink. When the relationship between the light absorption rate and the film thickness of the functional ink 43a is measured in advance, there is no need to measure it in a mass production process.

With reference to FIG. 10A, first in step S101, a functional ink is uniformly coated onto a substrate to be an object on which a film is formed by an inkjet method or a spin coating method, for example, to form a functional ink film.

Next, in step S102, a film thickness of the functional ink film formed in step S101 is measured. A film thickness of the functional ink film may be measured using a non-contact shape measuring machine, etc., using a light, etc. for example. More specifically, an interferometer New View series by Zygo Corporation, a laser shape-measuring microscope VK series by Keyence Corporation, etc., may be used, for example.

Next, in step S103, a light absorption rate of the functional ink film formed in step S101 is measured. The light absorption rate of the functional ink film may be measured using FTIR, UV-VIS-NIR Spectrometry, etc., for example. More specifically, IR series and UV series by Shimadzu Corporation, Lambda series by Perkin Elmer, Inc., etc., may be used, for example.

Next, in step S104, a functional ink film formed in step S101 is heated. In order to heat the functional ink film, an oven, an RTA, etc., may be used, for example. Moreover, a laser apparatus may be used.

Next, while determining whether there is a change in film thickness in step S105, steps S102-S104 are repeated, adjusting a laser power level or conditions on heating temperature and changing a phase state of the functional ink film. When it is determined that there is no change in film thickness (when YES) in step S106, information on states (the heating temperature, the laser power), the film thickness and the light absorption rate of the functional ink film are recorded.

Next, while determining whether a target film thickness is reached in step S107, steps S101 to S106 are repeated to perform wet-on-wet coating of the functional ink until the target film thickness is reached to continue recording information on the states (the heating temperature, the laser power), the light absorption rate and the film thickness of the functional ink film. In this way, a relationship between the light absorption rate and the film thickness of the functional ink film (functional ink 43a and 43b) is obtained.

FIG. 10B, which is a diagram illustrating an example of information obtained in step S102 in FIG. 10A, shows a relationship between the heating temperature and the film thickness of the functional ink film. In FIG. 10B, 601 represents a film thickness (approximately 170 nm) of the functional ink film when heated at 120° C. for one minute in a hot plate; 602 represents a film thickness (approximately 115 μm) of the functional ink film when heated at 300° C. for a few minutes in an oven; 603 represents a film thickness (approximately 90 nm) of the functional ink film when heated at 500° C. for a few minutes in the oven; and 604 represents a film thickness (approximately 75 nm) of the functional ink film when heated at 700° C. for a few minutes in the oven. While not shown in the present embodiment, it is a matter of course that a film thickness of the functional ink film at room temperature (approximately 25° C.) can be measured.

FIG. 12A, which is a diagram illustrating an example of information obtained in step S103 in FIG. 10A, shows a relationship between the film thickness and the light absorption rate of the functional ink film. FIG. 12A plots the light absorption rate when a light with a wavelength of approximately 1000 nm is irradiated. In FIG. 12A, a solid line represents a light absorption rate for a film thickness of the functional ink film of between 0 and 1000 μm when burned at 120° C. for a few minutes in the hot plate; a rough dotted line represents a light absorption rate for a film thickness of the functional ink film of between 0 and 1000 μm when burned at 500° C. for a few minutes in the oven; and a fine dotted line represents a light absorption rate for a film thickness of the functional ink film of between 0 and 1000 μm when burned at 700° C. for a few minutes in the oven.

With actual data being measured in increments of a few ten μm, FIG. 12A shows curve-fitted results. Spin coat film forming conditions or inkjet ejecting conditions can be changed to change a film thickness in increments of a few μm. While temperature points for measurement in the present embodiment are three points at 120° C., 500° C., and 700° C., it is a matter of course that more accurate information is obtained by obtaining data up to 25° C. or data in finer temperature increments.

Next, a method of calculating optimal laser power is described based on pre-measured results of FIGS. 10B and 12A. FIG. 12B is a diagram in which film thickness information (film thickness information at the time of heating from 120° C. to 700° C. that are obtained in FIG. 10B) obtained in FIG. 10B is plotted in FIG. 12A.

The film thickness is approximately 170 nm at 120° C. in FIG. 10B, so that plotting it on a light absorption rate curve (solid line) when heated at 120° C. in FIG. 12B yields a point denoted by 701. In the same manner as described above, plotting film thickness information when heated at 500° C. and when heated at 700° C. yields points denoted by 703 and 704.

FIG. 12B indicates that, when a light with a wavelength of approximately 1000 nm is irradiated to heat the functional ink film from 120° C. to 700° C., the light absorption rate changes non-linearly from approximately 52% to approximately 58% to approximately 46%. Wet-on-wet coating of the functional ink is performed for the second layer in the same manner as for the first layer (the final film thickness for the first layer is 75 nm, so that a thickness of the second layer after heating at 120° C. becomes 75 nm+170 nm=245 nm) and the light absorption rate and the film thickness are measured to plot in FIG. 12B to yield a point denoted by 801.

In the same manner as the above, film thickness information sets at times of heating at 500° C. and at 700° C. (approximately 165 μm at 500° C. and approximately 150 μm at 700° C.) are plotted on the respective curves to yield points denoted by 803 and 804. The light absorption rate for the second layer changes differently from that for the first layer in that it changes non-linearly from approximately 62% to approximately 42% to approximately 38%. In this way, a characteristic in which the light absorption rate varies substantially depending on the film thickness.

While a number of methods is possible for determining an optimal laser power for the respective layers of the laser apparatus which irradiates a laser light with a wavelength of approximately 1000 nm, center values of a light absorption rate change range can be used as one example. Based on the above-described results, a center value of the light absorption rate for the first layer is 52%, while a center value of the light absorption rate for the second layer is 50%. The light absorption rate for the second layer is slightly lower than that for the first layer, so that it is necessary to irradiate thereonto with a stronger laser power.

In the present embodiment, a film thickness of the respective layers is set to be constant, so that optimal laser power levels for the respective layers may be determined in proportion to the first laser power. For example, the optimal laser power for the first layer of 100 W (the optimal laser power to be a reference needs to be evaluated in advance) yields the optical laser power for the second layer of 52%/50% of 100 W, or 104 W. Similarly, for the second layer and beyond, the optimal laser power may be calculated easily.

While a case is explained of heating from 120° C. to 700° C. in a single process, when a heating process is performed which is divided into three stages of evaporation (120° C.), thermal decomposition (500° C.), and crystallization (700° C.), it is not necessary to use the central value of the light absorption rate of the respective states. For example, when only the evaporation process is to be performed in the laser apparatus, the light absorption rate of the first layer at 120° C. is 52% and the light absorption rate of the second layer at 120° C. is 62%, so that, when the optimal laser power for the first layer is 100 W (similarly, the optimal laser power to be a reference needs to be evaluated in advance) the optimal laser power for the second layer becomes 52%/62% of 100 W, or approximately 84 W. In a manner similar to this scheme, processes of thermal decomposition (500° C.) and crystallization (700° C.) may also be performed.

The optimal laser power to be the reference needs to be evaluated in advance. In the present embodiment, for a laser irradiating area of 1000 μm×50 μm, a laser wavelength of 980 nm, a laser beam profile of top hat (flat), and a substrate scanning speed of 100 mm/s, the optimal laser power was observed in the vicinity of 20 W to 40 W. For the functional ink film produced under the above-described conditions, there were no cracks, crystallization was favorable (checked by an XRD measurement apparatus, etc.), and piezoelectric element characteristics measured were also favorable.

In this way, in the first embodiment, based on the relationship between the film thickness and the light absorption rate of the coating film, an optimal laser power which corresponds to a film thickness of the coating film is calculated in advance, which calculated results are stored in a storage unit. Then, when continuously irradiating a laser light onto the coating film to evaporate a solvent of the coating film, a value of an optimal laser power which corresponds to the film thickness of the coating film that is stored in the storage unit is obtained and a laser light is irradiated onto the coating film with the optimal laser power which corresponds to the film thickness of the coating film. Moreover, when pulse irradiating a laser light onto a coating film in which the solvent was evaporated to crystallize the coating film in which the solvent was evaporated, a value of an optimal laser power which corresponds to the film thickness of the coating film that is stored in the storage unit is obtained and a laser light is irradiated onto the coating film with the optimal laser power which corresponds to the film thickness of the coating film. In this way, a laser light with a laser power which is optimal for the coating film may be irradiated even when a film forming process of the coating film is repeated, so that the film thickness of the coating film changes. In other words, even when the film thickness of the coating film changes, the coating film may be heated to a desired temperature. The film thickness of the coating film may be known from an ejected amount of liquid, etc., so that it is not necessary to measure the film thickness of the coating film before irradiating the laser light.

### Second Embodiment

A shape of the pattern image taken into the imaging unit 73 used in the first embodiment may be measured. In this way, whether a shape of the pattern produced is normal may be determined. For example, in FIG. 11, functional inks 43b₁, 43b₂, and 43b₄ show a normal pattern, while a functional ink 43b₃ shows a failure pattern.

The normal pattern of the functional ink 43b is stored in advance as data in the RAM or the non-volatile memory of the apparatus control unit (not shown). In this way, in the process shown in FIG. 7C, the apparatus control unit may detect a failure pattern by comparing a pattern image of the functional ink 43b that is imaged by the imaging unit 73 with a normal pattern stored in advance.

### Third Embodiment

In the first embodiment, the continuous laser irradiating apparatus 71 and the pulse laser irradiating apparatus 72 were used as separate apparatuses. In the third embodiment, the continuous laser irradiating apparatus 71 and the pulse laser irradiating apparatus 72 are arranged as one laser apparatus unit. More specifically, for example, a pulse laser irradiating apparatus such as a semiconductor fiber coupling laser apparatus, a semiconductor laser stack apparatus, etc., may be used to provide the one laser apparatus unit with functions of the pulse laser irradiating apparatus and the continuous laser irradiating apparatus.

In this way, processes of solvent evaporation, thermal decomposition, and crystallization of the functional ink may be performed by one laser apparatus unit. Moreover, for example, for a configuration in which the stage 62 has a degree of freedom of one axis in a Y-axis direction and the inkjet head 67, the continuous laser irradiating apparatus 71, and the pulse laser irradiating apparatus 72 are aligned in a Y-axis direction, the continuous laser irradiating apparatus 71 and the pulse laser irradiating apparatus 72 may be arranged as the one laser apparatus unit to shorten a length of a Y-axis direction of the stage drive unit. Therefore, not only a moving accuracy in a Y-axis direction improves, but an apparatus becomes compact, making a decreased apparatus cost possible.

### Fourth Embodiment

Normally, a shape of a laser irradiating area by laser heating is circular, while a beam profile is Gaussian. In this case, when the functional ink is irradiated at a circular laser irradiating area, an actual irradiating time differs between a center region of a circle and an edge portion of the circle. In other words, the circle center is irradiated longer, while the circle edge is irradiated shorter. Thus, the laser irradiating area is preferably arranged to have the same shape as the functional ink pattern or a shape which is larger than the functional ink pattern. In this way, the functional ink patterned to a predetermined shape may be heated uniformly.

Moreover, a beam profile of a laser irradiation by the continuous laser irradiating apparatus 71 and the pulse laser irradiating apparatus 72 can be arranged as a flat shape or a top hat shape within an irradiating area to more uniformly heat the functional ink. Adjustment of the beam profile and the shape of the irradiating area can be incorporated into either one of the continuous laser irradiating apparatus 71 and the pulse laser irradiating apparatus 72.

For example, when a plane shape of the functional ink is rectangular, for either one of the continuous laser irradiating apparatus 71 and the pulse laser irradiating apparatus 72, the irradiating area is preferably rectangular when a direction in which the stage 62 may simultaneously move is one direction. Then, a tilt of the rectangle and a tilt in a moving direction of the stage 62 are preferably aligned. In other words, a long side or a short side of the functional ink whose plane shape is rectangular is preferably parallel to the moving direction of the stage 62.

With such a configuration, the irradiating time in the moving direction of the stage 62 becomes the same in the moving direction and a direction orthogonal thereto of the stage 62. In other words, a uniform laser heating becomes possible, making it possible to form a highly reliable functional ink film.

### Fifth Embodiment

In a fifth embodiment, an excimer laser is used to perform laser irradiation before performing laser heating for crystallizing functional ink. A metal organic compound including a metal component is decomposed at a temperature which varies depending on the metal component included, so that a method of forming a crystal grain differs depending on the material. Therefore, the excimer laser is used to perform laser irradiation to achieve scission of a chemical bond and integrate a method of forming the crystal grain.

In this way, when a piezoelectric element is produced from the functional ink, a crystal film which is compact and which has equal grain diameters may be formed, so that piezoelectric element characteristics of the crystal film obtained improves. The chemical bond scission achieved by the excimer laser may be checked using an infrared absorption spectrum, etc. More specifically, after the solvent is evaporated by the continuous laser irradiating apparatus 71, an excimer laser, etc., with a wavelength of less than or equal to 300 nm is irradiated, for example.

More specifically, using a continuous irradiation-type KrF excimer laser apparatus, an excimer laser may be irradiated under irradiating conditions of a wavelength of between 230 to 280 nm and at least 100 mJ/cm² to improve the characteristics of functional ink film obtained. The same advantageous effect is achieved by irradiating ultraviolet rays using a UV lamp instead of the continuous irradiation-type KrF excimer laser apparatus.

### Sixth Embodiment

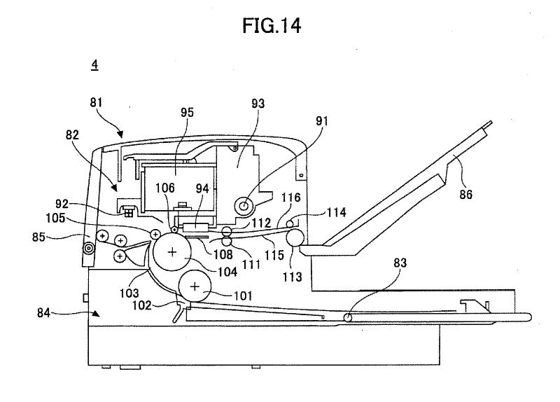

A sixth embodiment shows an example of an inkjet recording apparatus which has mounted thereon the liquid ejecting head 2 (see FIG. 2) which is manufactured by the thin film manufacturing apparatus 3. FIG. 13 is a perspective view exemplifying an inkjet recording apparatus. FIG. 14 is a side view exemplifying a machinery section of the inkjet recording apparatus.

With reference to FIGS. 13 and 14, an inkjet recording apparatus 4 includes, within a recording apparatus body 81 thereof, a printing machinery unit 82, etc., including a carriage 93 which is movable in a main scanning direction, an inkjet recording head 94, which is one embodiment of the liquid droplet ejecting head 2 mounted on the carriage 93; an ink cartridge 95 which supplies ink to the inkjet recording head 94, etc.

At a lower part of the recording apparatus body 81, a paper-feeding cassette 84 (or may also be a paper feeding tray) on which a large number of sheets 83 can be stacked may be mounted such that it can be pulled out or inserted. Moreover, a manual tray 85 for manually feeding the sheet 83 may be opened or put down. Taking in the sheet 83 fed from the paper-feeding cassette 84 or the manual tray 85, the print machinery unit 82 records required images, after which it conducts sheet discharging onto the paper-discharging tray 86 mounted on the back face side.

The printing machinery unit 82 holds the carriage 93 with a primary guide rod 91 and a secondary guide rod 92, which are guide members laterally bridging between right and left side plates (not shown) such that the carriage 93 can slide in the main scanning direction). On the carriage 93, an inkjet recording head 94 which ejects ink droplets of respective colors of yellow (Y), cyan (C), magenta (M), and black (Bk) ink is mounted such that multiple ink ejecting outlets (nozzles) are aligned in a direction which crosses the main scanning direction and an ink droplet ejecting direction faces downwards. Moreover, the carriage 93 has replaceably mounted ink cartridge 95 for supplying ink of each color to the inkjet recording head 94.

The ink cartridge 95 has an atmospheric opening (not shown) which is communicatively connected to the atmosphere at an upper portion thereof, a supply port (not shown) which supplies ink to the inkjet recording head 94 at a lower portion thereof, and a porous body (not shown) which is filled with ink inside thereof. A capillary force of the porous body keeps ink supplied to the recording head 94 to a slightly negative pressure. Moreover, while heads of each color are used here as the inkjet recording head 94, one head may be used which has nozzles ejecting ink droplets of respective colors.

The carriage 93 has the downstream side in a sheet conveying direction thereof slidably fitted to the primary guide rod 91, and has the upstream side in the sheet conveying direction thereof slidably placed on the secondary guide rod 92. Then, in order to move and scan this carriage 93 in the main scanning direction, a timing belt 100 is stretched between a drive pulley 97 and a follower pulley 98 that are rotationally driven by the main scanning motor 97, and the carriage 93 is driven in both ways by rotation of the main scanning motor 97 in normal and reverse directions. The timing belt 100 is fixed to the carriage 93.

Moreover, the inkjet recording apparatus 4 is provided with a friction pad 102, a paper feeding roller 101 which feeds the sheet 83 one by one from the paper-feeding cassette 84, a guide member 103 which guides the sheet 83, a conveying roller 104 which reverses the fed sheet 83 to convey the reversed sheet 83, a conveying roller 105 which is pushed against a peripheral face of the conveying roller 104, and a leading-end roller 106 which defines an angle of sending out the sheet 83 from the conveying roller 104. In this way, the sheet 83 which is set to the paper-supplying cassette 84 is conveyed to the lower side of the inkjet recording head 94. The conveying roller 104 is rotationally driven via a row of gears by a sub-scanning motor 107.

A print receiving member 109, which is a sheet guide member, guides, on the lower side of the recording head 94, the sheet 83 sent out from the conveying roller 104 in correspondence with a moving range of the carriage 93 in the main scanning direction. On the downstream side of the print receiving member 109 in the sheet conveying direction are provided a spur 112, and a conveying roller 111, which is rotationally driven to send out the sheet 83 in a discharging direction. Moreover, there are provided a spur 114, and a discharging roller 113, which sends out the sheet 83 to the paper-discharging tray 86, and guide members 115 and 116, which form a paper-discharge path.

At the time of image recording, the inkjet recording head 94 is driven according to an image signal while moving the carriage 93 to eject ink onto sheets 83 at rest to record what amounts to one line, and the following line is recorded after the sheets 83 are conveyed for a predetermined amount. When a recording termination signal or a signal that a trailing edge of the sheet 83 has reached the end of the recording area is received, the recording operation is terminated, so that the sheets 83 are discharged.

At a position which is off the recording area on the right end side in a moving direction of the carriage 93 is provided a recovery apparatus 117 for recovering an ejection failure of the inkjet recording head 94. The recovery apparatus 117 has a cap unit, an absorption unit, and a cleaning unit. During the time of waiting for a print, the carriage 93 is moved to the recovery apparatus 117 side and has the inkjet recording head 94 capped with a capping unit, preventing an ejection failure due to drying of ink by maintaining an ejecting outlet in a wet state. Moreover, ink which is not related to recording is ejected at a time such as in the middle of recording, making the viscosity of ink at all the ejecting outlets constant, and maintaining a stable ejection performance.

When an ejection failure, etc., occurs, the ejecting outlet of the inkjet recording head 94 is sealed with a capping unit, and air bubbles, etc., as well as ink are suctioned from the ejecting outlet through a tube by the suction unit. Moreover, ink, dust, etc., which are adhered to the ejecting outlet face is removed by a cleaning unit so as to recover from the ejection failure. Moreover, the suctioned ink is discharged into a waste ink reservoir (not shown) installed at a lower portion of the body, and is absorbed and kept by an ink absorber inside the waste ink reservoir.

In this way, as the inkjet recording apparatus 4 has mounted therein an inkjet recording head 94, which is one embodiment of the liquid ejecting head 2 manufactured by the thin film manufacturing apparatus 3, it has no ink droplet ejection failure and a stable ink droplet ejection characteristic is obtained, making it possible to improve image quality.

### Example

Next, an example is described which forms a thin film using the thin film manufacturing apparatus 3. In this example, a thermal oxide film (with a film thickness of 1 μm) is formed on a silicon wafer and, as a contact layer, a titanium film (with a film thickness of 50 nm) is formed by sputtering. Then, as a lower electrode, a platinum film (with a thickness of 200 nm) formed by sputtering.

Next, the substrate is immersed in a solution of alkanethiol using CH₃(CH₂)₆—SH at a concentration of 0.01 mol/l (solvent: isopropyl alcohol), and is subjected to an SAM treatment. Thereafter, the substrate is, after being washed by isopropyl alcohol and dried, undergoes a patterning process.

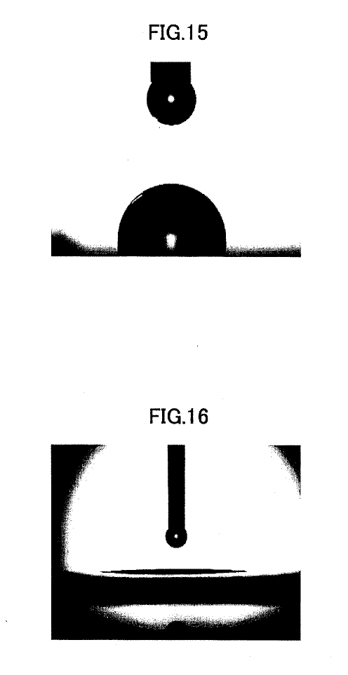

A water contact angle measured in a SAM film forming part (on the SAM film) after the SAM treatment was 92.2°. (see FIG. 15) On the other hand, a water contact angle measured on a platinum-sputtered film before the SAM treatment was less than equal to 5° (fully wet). The above described results demonstrate that the SAM film treatment was performed properly.

Next, a film was formed by applying a photoresist (TSMR8800) manufactured by Tokyo Ohka Kogyo Co., Ltd. by a spin coating method, and a resist pattern has been formed by a conventional photolithography scheme, after which an oxygen plasma treatment was performed to remove the SAM film of an exposed portion. A residual resist after the treatment was dissolved and removed by acetone, and a similar evaluation of the contact angle as described above was carried out to find that the water contact angle in the SAM film removing part was less than or equal to 5° (fully wet, see FIG. 16), and that at a part covered with the resist was 92.4°. It may be confirmed from the above-described results that patterning of the SAM film was performed properly.

As a different patterning scheme, a resist pattern was formed in advance by a similar resist work and a similar SAM film treatment was carried out, after which the resist was removed by acetone, and a contact angle was measured. A contact angle on a portion of the platinum film covered with the resist was less than or equal to 5° (fully wet), and that at other portions was 92.0° to confirm that the patterning of the SAM film was performed properly.

As one further scheme, ultraviolet rays were irradiated using a shadow mask. More specifically, a vacuum ultrasonic light with a wavelength of 176 nm by an excimer lamp is used to irradiate for 10 minutes. A contact angle of an irradiating portion was less than or equal to 5° (fully wet), and that at a non-irradiating portion was 92.2° to confirm that the patterning of the SAM film was performed properly.

Next, a film of PZT (53/47) was formed as an electro-mechanical transducer film. For synthesizing the precursor coating solution, lead acetate trihydrate, titanium isopropoxide, and zirconium isopropoxide were used as starting materials. Combined water of lead acetate was dissolved in methoxyethanol, after which it was dehydrated. An amount of lead relative to the stoichiometric composition was arranged to be 10 mol % excess. This is to prevent a decrease in crystallizability due to a so-called lead falling out in the thermal treatment.

Titanium isopropoxide and zirconium isopropoxide are dissolved in methoxyethanol, subjected to an alcohol exchange reaction and an esterification reaction, and mixed with a methoxyethanol solution in which is dissolved the above-described lead acetate to synthesize a PZT precursor solution. The PZT concentration is arranged to be 0.1 mol/liter.

A film thickness obtained in a one time sol-gel film forming is preferably 100 nm, and a precursor concentration is made adequate based on a relationship between a film forming area and a precursor coating amount. (Thus, it is not limited to 0.1 mol/l.)

This precursor solution is coated on the above-described patterned SAM film using an inkjet method (see FIG. 7A). Using the inkjet method liquid droplets are ejected not on the SAM film and only onto the hydrophilic portion, so that a coating film was formed only on the hydrophilic portion due to a contrast in the contact angle.

Using the continuous laser irradiating apparatus 71, a laser light irradiation and heating were performed on the coating film, a solvent is evaporated, obtaining a thermally decomposed coating film (see FIG. 7B). Next, the thermally decomposed coating film was imaged by the imaging unit 73, and an optimal laser power to be irradiated onto the thermally decomposed coating film, from the imaged pattern image (see FIG. 7C). Then, using the pulse laser irradiating apparatus 72, laser light irradiation and heating were performed on the thermally decomposed coating film only to crystallize the thermally decomposed coating film (see FIG. 7D). At this time, an optimal laser power determined in FIG. 7C were irradiated.

Here, as the thickness of the coating film coated on the patterned SAM film by the inkjet method may be determined from a coating amount, data on a laser power corresponding to a film thickness of coating film that is recorded in advance are read, and the continuous laser irradiating apparatus 71 and the pulse laser irradiating apparatus 72 are operated with the read laser power (the laser light was successively irradiated.)

Liquid droplets were ejected onto the same position by an inkjet method, a process of performing laser light irradiation by the continuous laser irradiating apparatus 71 and the pulse laser irradiating apparatus 72 were repeated 15 times to perform wet-on-wet coating to obtain an electro-mechanical transducer film of 500 nm. No failures such as cracks, etc., occurred for the electromechanical transducer film produced.

Liquid droplets were ejected onto the same position by an inkjet method, a process of performing laser light irradiation by the continuous laser irradiating apparatus 71 and the pulse laser irradiating apparatus 72 were further repeated 15 times (for a total of 30 times), but no failures such as cracks, etc., occurred in the electromechanical transducer film. The film thickness of the electromechanical transducer film reached 1000 nm.

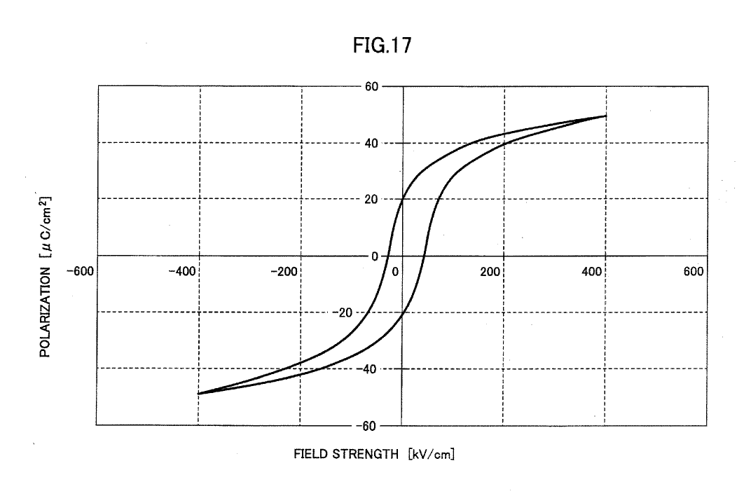

An upper electrode (platinum) film is formed onto the patterned electro-mechanical transducer film to produce an electro-mechanical transducer element to evaluate electrical characteristics and electromechanical transducer performance (a piezoelectric constant). FIG. 17 is graph showing a P-E hysteresis curve of the electro-mechanical transducer element manufactured in the present example. It was found that, the electro-mechanical transducer film has equivalent properties as normal sintered ceramics with a relative permittivity of 1220, a dielectric loss of 0.02, a residual polarization of 19.3 μC/cm², and a coercive electric field of 36.5 kV/cm.

The electro-mechanical transducer performance of the electro-mechanical transducer element was calculated by measuring a deformation amount due to electric field application with a laser Doppler vibrometer and calibrating by a simulation. The piezoelectric constant d31 thereof became −20 pm/V, which also was equivalent to that of the sintered ceramics. This is a characteristic value which may be adequately designed as a liquid droplet ejecting head.

Oxides such as LaNiO₃, SrRuO₃, etc., and platinum may be dissolved in a solvent, coating and laser irradiation are performed by an inkjet method to also form an electrode film in the same manner as the electro-mechanical transducer film.

While preferred embodiments and examples have been described in the above in detail, they are not limited to the above-described embodiments and examples, so that various changes and modifications may be added to the above-described embodiments and examples without departing from a scope recited in the claims.

The present application is based on Japanese Priority Application No. 2011-286156 filed on Dec. 27, 2011, Japanese Priority Application No. 2011-286157 filed on Dec. 27, 2011, and Japanese Priority Application No. 2011-286158 filed on Dec. 27, 2011, the entire contents of which are hereby incorporated by reference.

1. A thin film manufacturing apparatus, comprising:
a liquid ejecting unit which ejects a liquid onto an object on which a film is to be formed and which forms a coating film;
a first laser irradiating unit which continuously irradiates a laser light onto the coating film and which evaporates a solvent of the coating film; and
a second laser irradiating unit which irradiates a laser light pulse onto the coating film of which the solvent is evaporated and which crystallizes the coating film of which the solvent is evaporated.

2. The thin film manufacturing apparatus as claimed in claim 1, further comprising:
a laser power storage unit which calculates in advance and stores a laser power corresponding to a film thickness of the coating film based on a relationship between the film thickness and a light absorption rate of the coating film, wherein the first laser irradiating unit and the second laser irradiating unit obtains a value of the laser power corresponding to the film thickness of the coating film, and irradiates, onto the coating film, the laser light with the laser power corresponding to the film thickness of the coating film.

3. The thin film manufacturing apparatus as claimed in claim 2, wherein a wavelength of the laser light irradiated by the respective first laser irradiating unit and the second laser irradiating unit is at least 400 nm.

4. The thin film manufacturing apparatus as claimed in claim 1, wherein a shape of a laser light irradiating region on the object on which the film is to be formed of the second laser irradiating unit is identical to a shape of the coating film in which the solvent is evaporated.

5. The thin film manufacturing apparatus as claimed in claim 1, wherein a length in a direction orthogonal to a moving direction of the object on which the film is to be formed of a laser light irradiating region of the first laser irradiating unit is identical to a length in a direction orthogonal to the moving direction of the object on which the film is to be formed of the coating film.

6. The thin film manufacturing apparatus as claimed in claim 5, wherein a shape of the coating film is rectangular, and a shape of the laser light irradiating region on the object on which the film is to be formed of the first laser irradiating unit or the second laser irradiating unit is rectangular.

7. The thin film manufacturing apparatus as claimed in claim 6, wherein a light intensity distribution of the laser light irradiated by the first laser irradiating unit or the second laser irradiating unit is of a top hat shape.

8. The thin film manufacturing apparatus as claimed in claim 1, further comprising:
an ultraviolet ray irradiating unit which irradiates ultraviolet rays onto the coating film of which the solvent is evaporated and which achieves a chemical bond scission within the metal organic compound contained in the coating film.

9. A thin film manufacturing method, comprising:
forming a liquid-repellant region and a liquid-philic region on a surface of an object on which a film is to be formed;
ejecting a liquid onto the liquid-philic region and forming a coating film;
irradiating a continuous laser light onto the coating film and evaporating a solvent of the coating film; and
irradiating a laser light pulse onto the coating film of which the solvent is evaporated and crystallizing the coating film of which the solvent is evaporated.

10. The thin film manufacturing method as claimed in claim 9, further comprising:
calculating in advance and storing a laser power corresponding to a film thickness of the coating film based on a relationship between the film thickness and a light absorption rate of the coating film, wherein, in the continuous laser light irradiating and the laser light pulse irradiating, a value is obtained of the laser power corresponding to the film thickness of the coating film in the laser power storing, and the laser light is irradiated, onto the coating film with the laser power corresponding to the film thickness of the coating film.

11. A thin film manufacturing apparatus, comprising:
a liquid ejecting unit which ejects a liquid onto an object on which a film is to be formed and which forms a coating film;
an imaging unit which images the coating film;
a color depth converting unit which converts a color of an image imaged by the imaging unit into a color depth;
a film thickness calculating unit which calculates a film thickness of the coating film from the color depth;
an irradiating power calculating unit which calculates an irradiating power corresponding to the film thickness calculated by the film thickness calculating unit; and
a laser irradiating unit which irradiates, onto the coating film, a laser light with the irradiating power calculated by the irradiating power calculating unit.

12. The thin film manufacturing apparatus as claimed in claim 11, wherein the laser irradiating unit irradiates a pulse-shaped laser light onto the coating film, and heats and crystallizes the coating film.

13. The thin film manufacturing apparatus as claimed in claim 11, further comprising a continuous laser irradiating unit which continuously irradiates, onto the coating film, the laser light with the irradiating power calculated by the irradiating power calculating unit and which thermally decomposes the coating film.

14. The thin film manufacturing apparatus as claimed in claim 11, further comprising a shape determining unit which recognizes a shape of the coating film based on the image imaged by the imaging unit and determines whether the shape is normal.

15. A thin film manufacturing method, comprising:
a region forming step of forming a liquid-repellant region and a liquid-philic region on a surface of an object on which a film is to be formed;
a coating film forming step of ejecting a liquid onto the liquid-philic region and forming a coating film;
an imaging step of imaging the coating film;
a color depth converting step of converting a color of an image imaged in the imaging step into a color depth;
a film thickness calculating step of calculating a film thickness of the coating film from the color depth;
an irradiating power calculating step of calculating an irradiating power corresponding to the film thickness calculated in the film thickness calculating step; and
a laser irradiating step of irradiating, onto the coating film, a laser light with the irradiating power calculated in the irradiating power calculating step.
